(19) United States
(12) Patent Application Publication
(10) Pub. No.: US 2014/0090300 A1
(43) Pub. Date: Apr. 3, 2014

(54) DOOR ACTUATOR ASSEMBLY AND METHOD

(71) Applicant: Mark Hoffmann, Waterloo, IL (US)

(72) Inventor: Mark Hoffmann, Waterloo, IL (US)

(21) Appl. No.: 14/043,300

(22) Filed: Oct. 1, 2013

Related U.S. Application Data
(60) Provisional application No. 61/708,799, filed on Oct. 2, 2012.

(51) Int. Cl. B65D 88/58; E05F 15/20

(52) U.S. Cl. CPC B65D 88/58; E05F 15/2076
USPC 49/25; 49/281; 49/280; 49/506

(57) ABSTRACT

A door actuator assembly comprising a base plate mounted to a container. The container includes a distribution orifice and a trap door mounted to the container that moves selectively between a closed position covering the distribution orifice, and an open position not fully covering the distribution orifice. The assembly includes a hook member mounted to the base plate including a hook. The hook engages with the trap door. The trap door moves linearly when the hook member moves. The assembly includes a hook actuator assembly mounted to the base plate, including a hook actuation arm coupled to the hook member. The hook actuation arm extends and retracts, moving the hook member linearly along the base plate when the hook actuation arm extends and retracts, causing the hook member to move the trap door selectively between the closed position and the open position.

### FIELD OF THE DISCLOSURE

This disclosure relates to door actuators and, more particularly, to a door actuator device that is attachable to bins containing aggregate material.

### BACKGROUND

Material such as seed, sand, cement, soil, or any other type of aggregate material can be stored and distributed using bulk material containers having hopper bottoms. The hopper bottoms of such containers normally form a distribution orifice selectively coverable by a trap door. When the trap door is moved into an open position such that the distribution orifice is uncovered, the stored aggregate material is allowed to flow out of the container. In typical containers, the trap door is manually operated by sliding a trap door having a handle disposed on a side of the container.

Presently used methods for distributing aggregate materials from bulk containers have been to lift the container, for example, by a forklift, such that it hovers above a location in which the aggregate material will be deposited. For example, if a container is filled with seed, a forklift, crane or other lifting device may raise the container above a hopper of a planting machine. While the container is in this position, an operator must climb up to the container to manually open the trap door on the container, allowing seed to flow out of the container and into a receptacle. When sufficient seed has been dispensed from the container, the operator must then manually close the trap door and then lower the container back to the ground. As can be appreciated, depending on application, the dispensing of the aggregate material from the container in this fashion presents challenges to the operator both in reaching the container for manual operation of the dispensing process as well as in moving the trap door with enough force to close or open it under the weight of the aggregate material present in the container.

### SUMMARY

In an embodiment, the present disclosure describes a door actuator assembly that has a base plate adapted to be mounted to a container. The container includes a distribution orifice and a trap door slidably mounted to the container such that the trap door can move selectively between a closed position, in which the trap door fully covers the distribution orifice, and an open position, in which the trap door does not fully cover the distribution orifice. The door actuator assembly also includes a hook member slidably mounted to the base plate that has a hook disposed at a hook end of the hook member. The hook can mateably engage with the trap door of the container such that the trap door can move linearly when the hook member moves linearly. The door actuator assembly also has a hook actuator assembly mounted to the base plate. The hook actuator assembly includes a hook actuation arm coupled to the hook member. The hook actuation arm is adapted to extend and retract such that the hook actuation arm moves the hook member linearly along the base plate when the hook actuation arm extends and retracts, causing the hook member to move the trap door selectively between the closed position and the open position.

In another embodiment, the present disclosure describes a door actuator assembly comprising a base plate adapted to be mounted to a container. The container includes a distribution orifice and a trap door slidably mounted to the container. The trap door is configured to move selectively between a closed position, in which the trap door fully covers the distribution orifice, and an open position, in which the trap door does not fully cover the distribution orifice. The door actuator assembly also includes a hook member slidably mounted to the base plate. The hook member includes a hook disposed at a hook end of the hook member. The hook is adapted to mateably engage with the trap door of the container such that the trap door is adapted to move linearly when the hook member moves linearly. The door actuator assembly also includes a hook actuator assembly mounted to the base plate. The hook actuator assembly includes a hook actuation arm coupled to the hook member. The hook actuation arm is adapted to selectively extend and retract. The hook actuator assembly also includes a hook actuator motor configured to power the hook actuation arm to selectively extend and retract. The hook actuation arm moves the hook member linearly along the base plate when the hook actuation arm extends and retracts, causing the hook member to move the trap door selectively between the closed position and the open position. The door actuator assembly has a fixed clamp extending from a first end of the base plate, and an actuating clamp pivotally mounted to and extending from a second end of the base plate. The container is positionable between the fixed clamp and the actuating clamp when the base plate is mounted to the container. The actuating clamp is adapted to selectively move between a closed position, in which the actuating clamp and the fixed clamp are both in contacting relationship with the container, and an open position, in which at least one of the fixed clamp and the actuating clamp is not in contacting relationship with the container. The door actuator assembly also includes a clamp actuator assembly mounted to the base plate. The clamp actuator assembly includes a clamp actuation arm configured to selectively retract and extend. The clamp actuation arm is coupled to the actuating clamp such that the actuating clamp is in the closed position when the clamp actuation arm is retracted, and the actuating clamp is in the open position when the clamp actuating arm is extended. The clamp actuator assembly also has a clamp actuator motor configured to selectively extend and retract the clamp actuation arm.

In yet another embodiment, the present disclosure includes a door actuating method comprising mounting a base plate to a container. The container includes a distribution orifice and a trap door slidably mounted to the container. The trap door is configured to move selectively between a closed position, in which the trap door fully covers the distribution orifice, and an open position, in which the trap door does not fully cover the distribution orifice. The method also includes slidably mounting a hook member to the base plate. The hook member includes a hook disposed at a hook end of the hook member. The method includes mateably engaging the hook member with the trap door of the container such that the trap door is adapted to move linearly when the hook member moves linearly. The method also includes mounting a hook actuator assembly to the base plate. The hook actuator assembly includes a hook actuation arm coupled to the hook member, and the hook actuation arm is adapted to selectively extend and retract. The method also includes extending and retracting the hook actuation arm such that the hook actuation arm moves the hook member linearly along the base plate when the hook actuation arm extends and retracts, causing the hook member to move the trap door selectively between the closed position and the open position.

### BRIEF DESCRIPTION OF THE DRAWINGS

FIG. 1 is a perspective view a door actuator assembly of the present disclosure mounted to a container in accordance with the present disclosure.

FIG. 2 is a partial bottom angled view of a distribution orifice and a trap door of the container of FIG. 1.

FIG. 3 shows a partial perspective view of a trap door of the container of FIG. 1.

FIG. 4 is an enlarged perspective view of the door actuator assembly of FIG. 1.

FIG. 5 is an enlarged perspective view of a clamp actuator assembly of the door actuator assembly of FIG. 1.

FIG. 6 is a partial top perspective view of the door actuator assembly of FIG. 1 in a closed position.

FIG. 7 is a partial top perspective view of the door actuator assembly of FIG. 1 in an open position.

FIG. 8 is a cross-sectional view of the door actuator assembly of FIG. 1 in a closed position.

FIG. 9 is a cross-sectional view of the door actuator assembly of FIG. 1 in an open position.

FIG. 10 is a partial bottom perspective view of the door actuator assembly of FIG. 1 in an open position.

### DETAILED DESCRIPTION

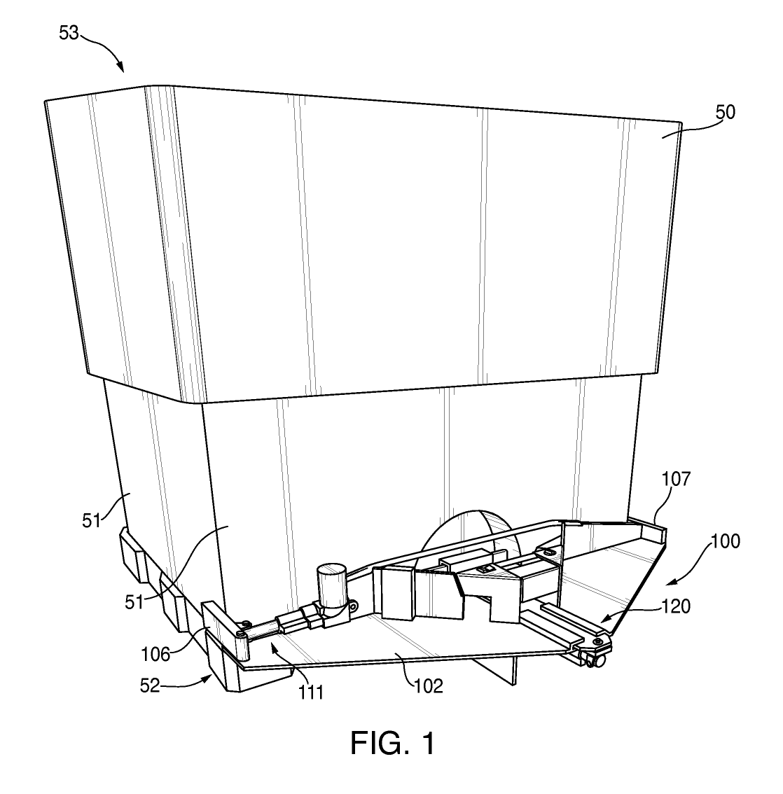

This disclosure relates to machinery and systems for use with bulk containers, specifically bulk aggregate material containers. A door actuator assembly of the present disclosure is a device that can be used to remotely open a trap door on a container. FIG. 1 shows an embodiment of a door actuator assembly 100 mounted to a bulk material container 50 having a hopper bottom 52 through which aggregate material can selectively pass. Bulk material containers, such as the container 50 shown in FIG. 1, can be used to store and distribute various types of aggregate or other materials, such as seed, grain, sand, or other suitable aggregate material. It is contemplated, however, that the disclosed door actuator assembly 100 can be used with other types of containers. The container 50 can have side walls 51, a removable top 53, and the hopper bottom 52 to retain stored material. Alternative container configurations, however, may not have a top or collapsible walls. The hopper bottom 52 can have a trap door system that can remain closed when material is stored or transported, but can be opened to allow gravity-powered egress of the material in the container through an orifice formed in the under-side of the container when the door is open. The rate of material egress may be determined by the opening extent of the door.

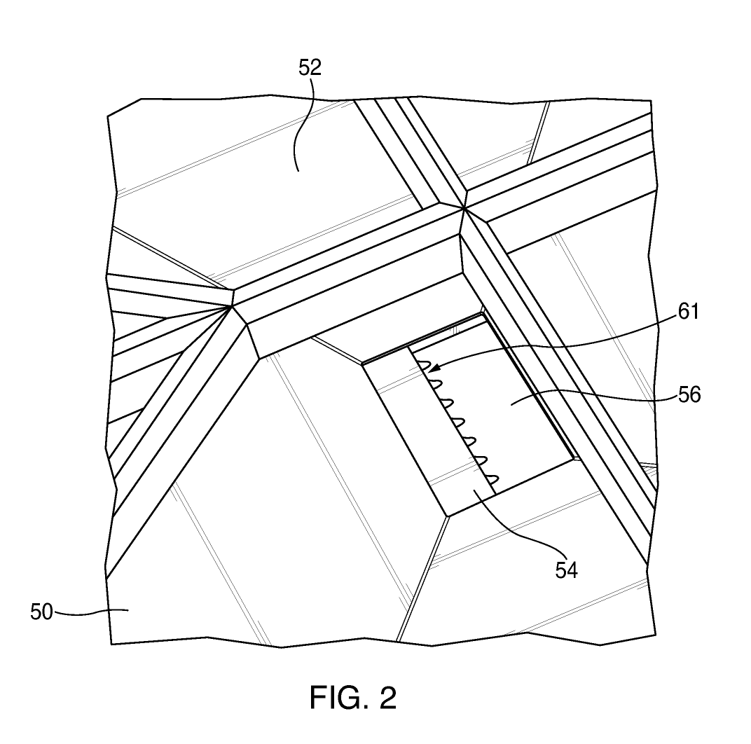

FIG. 2 illustrates an embodiment of the hopper bottom 52 with a trap door system in a partially open position. A trap door 54 having a handle end 60 and an orifice end 61 can be slidably mounted to the container 50 and configured to selectively cover or uncover a distribution orifice 56 formed in the hopper bottom 52, defining a closed position and open positions, respectively. The trap door 54 open positions can be either fully open or partially open, depending on how much of the distribution orifice 56 is covered. When in the closed position, the trap door 54 can substantially prevent stored aggregate material from flowing out of the container 50. When the trap door 54 is in the partially open or fully open positions, aggregate material is allowed to flow through the distribution orifice 56 and out of the container 50. The position of the trap door 54 between the fully open position and the closed position can affect the rate in which material flows out of the container 50. Specifically, the greater portion of the distribution orifice 56 that the trap door 54 covers, the lower the flow rate will be.

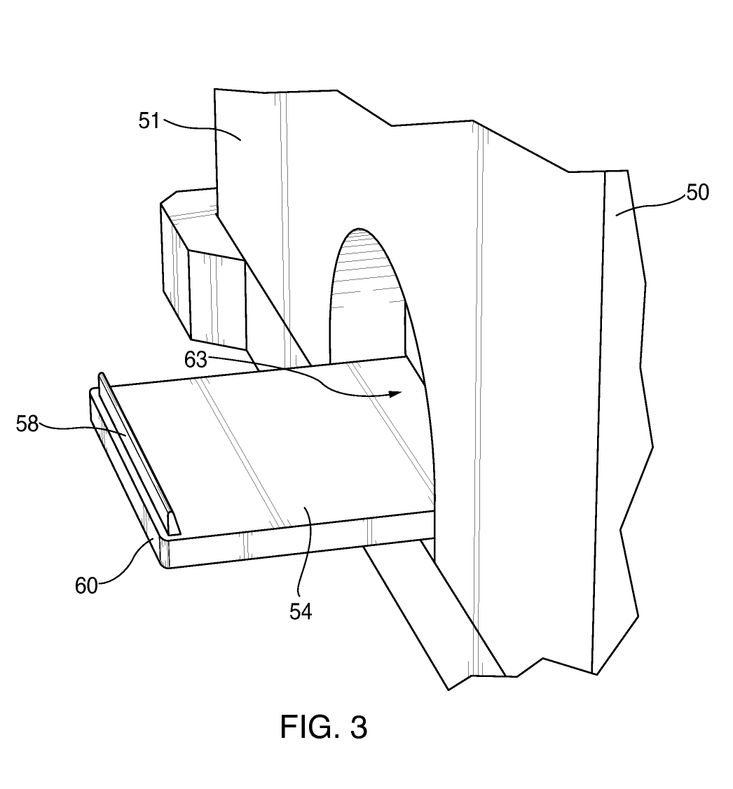

FIG. 3 illustrates the trap door 54 protruding from the side wall 51 of the container 50 without the door actuator assembly 100 mounted. A trap door handle 58 is disposed on the trap door 54 at the handle end 60. In the embodiment illustrated in FIG. 2 and FIG. 3, the trap door 54 fits within a trap door slot 63 formed in the hopper bottom 52 and protrudes out substantially perpendicularly to the side wall 51, terminating at the handle end 60. The trap door slot 63 can be formed in the hopper bottom 52 between the distribution orifice 56 and the side wall 51. The trap door 54 can be configured to slide within the trap door slot 63 such that the trap door moves towards the closed position covering the distribution orifice 56 when the trap door handle 58 is moved toward the distribution orifice. When the trap door moves toward the open position, the trap door handle is moved away from the distribution orifice. In some embodiments, the trap door 54 can be in the closed position when the handle end 60 of the trap door is substantially flush with the side wall 51. Thus, in practice, the trap door handle 58 can be pulled away from the side wall 51 to open the trap door 54 and allow aggregate material to flow out of the container 50 through the distribution orifice 56. When distribution is complete, the trap door handle 58 can be moved toward the side wall 51, causing the trap door 54 to cover the distribution orifice and halt flow of the aggregate material.

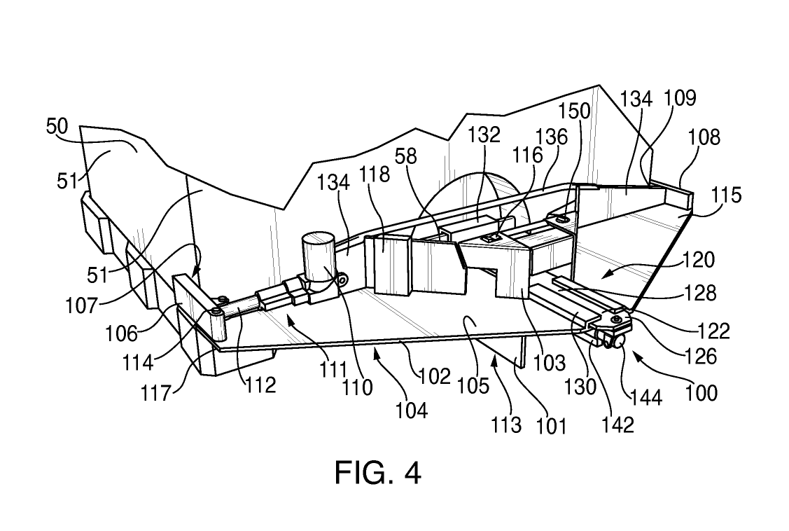

FIG. 4 illustrates an embodiment of the door actuator assembly 100 mounted to a container 503. When the door actuator assembly 100 is attached to the container 50, a hook assembly 120 can engage the trap door handle 58 of the container and can move the trap door 54 between open, closed, and intermediate positions under force provided by an actuator. In some embodiments, the actuator can be associated with a controller having a remote control capability.

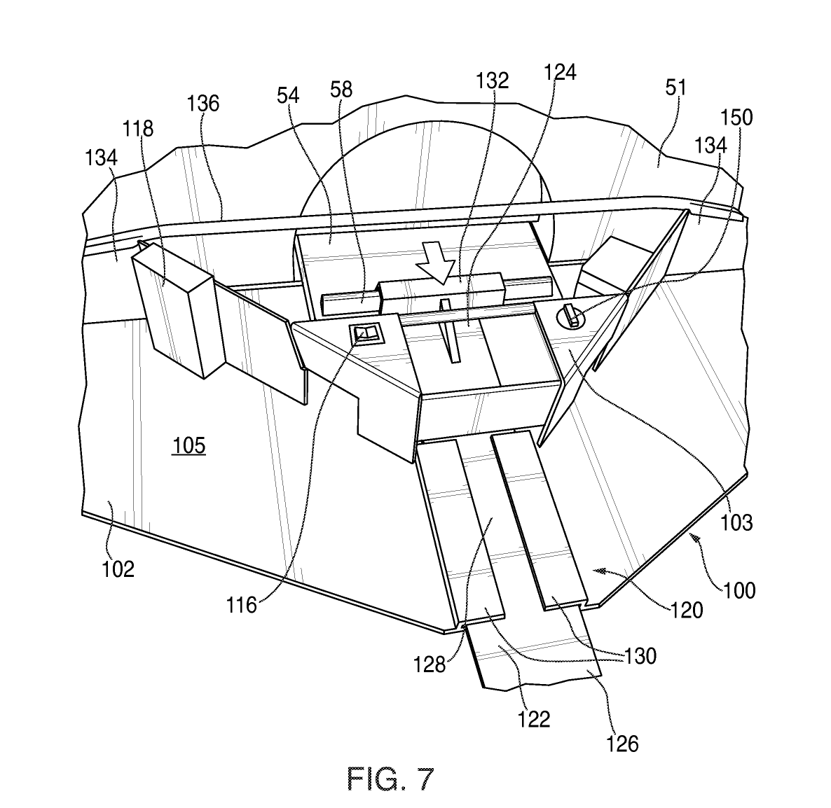

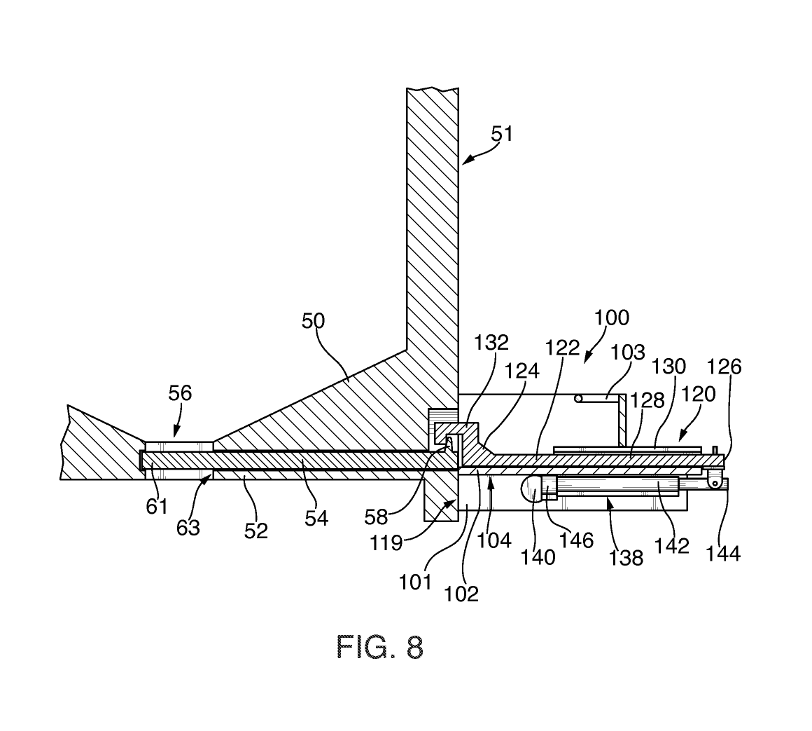

In the illustrated embodiment, the door actuator assembly 100 can have a base plate 102 that can have a bottom side 104, a top side 105, a first end 115, and a second end 117, and can be made from a variety of suitable materials, such as metal, plastic, composite, etc. The door actuator assembly 100 can have a housing structure 103 mounted on the top side 105 of the base plate 102, and at least one support plate 101 mounted on the bottom side 104 of the base plate. The support plates 101 can be substantially perpendicular to the base plate 102. In the illustrated embodiment, each support plate 101 presents a bottom edge 113 useful to supporting the door actuator assembly 100 on the floor or other surface when not in use. As shown in FIG. 7 and FIG. 8, an inward edge 119 of each support plate 101 can abut the side wall 51 of the container 50 when the assembly 100 is mounted to the container to help align and support the door actuator assembly in the mounted position.

A clamping system used to attach the door actuator assembly 100 to the container 50 is adapted or configured for attachment to the base plate 102. The clamping system can have at least two clamps 106, 108, at least one of which can be an actuating clamp 106 and at least one of which can be a fixed clamp 108. The fixed clamp 108 can be disposed at the first end 115 of the base plate 102 and extend therefrom, and the actuating clamp 106 can be pivotally mounted to and extend from the second end 117 of the base plate. Although the illustrated embodiment shows one actuating clamp 106 and one fixed clamp 108, it is contemplated that multiple actuating or otherwise movable clamps can be used in some embodiments. Each clamp 106, 108 can have a container engaging surface 107, 109 facing generally toward one another such that the container can be positioned between the fixed clamp and the actuating clamp. In the illustrated embodiment, the engaging surfaces 107, 109 of the clamps 106, 108 are in facing relationship and configured or adapted such that two opposing side walls 51 of the container 50 are engaged therebetween when the clamps 106, 108 are engaged. Engagement of the clamps 106, 108 onto the container 50 operates to substantially rigidly attached the door actuator assembly 100 onto the container 50 such that the door actuator assembly 100 can be moved along with the container 50 by physical engagement of fitting structures and/or by friction between the engaging surfaces 107 and 109 and the container walls.

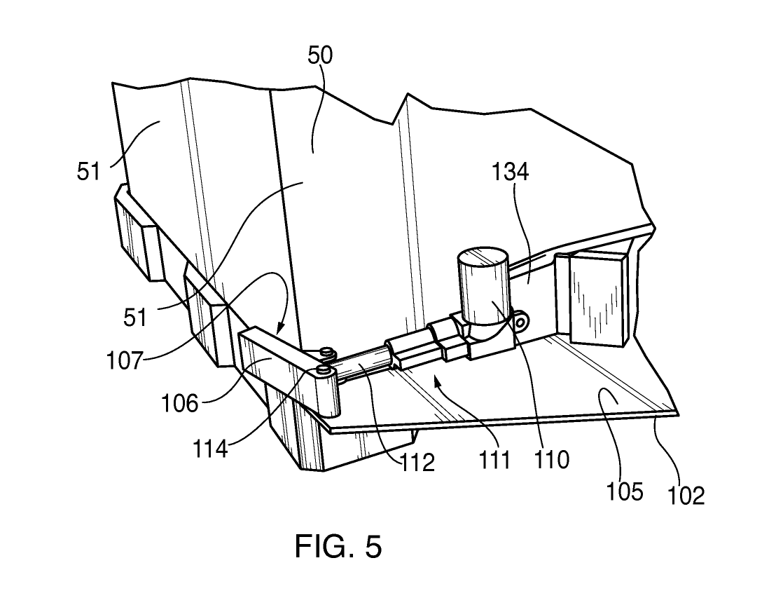

In the illustrated embodiment, the door actuator assembly 100 includes a clamp actuator assembly 111 configured to selectively move the actuating clamp 106 between an open position and a closed position. The clamp actuator assembly has a clamp actuator motor 110 that is attached to the top surface 105 of the base plate 102 and an actuation arm 112 connecting the clamp actuator motor 110 and the actuating clamp 106. The actuator motor 110 operates to move the actuating clamp 106 outward by extending the actuation arm 112, and moves the actuating clamp inward by retracting the actuation arm. Although the actuation arm 112 in the illustrated embodiment is a telescoping arm having a piston and a cylinder, it is contemplated that other types of actuation arms can be used, such as linkages or other suitable construction. The actuating clamp 106 is configured to move between a closed position, such as illustrated in FIG. 4, and an open position, such as illustrated in FIG. 5. In the open position, the actuating clamp 106 is positioned outward and away from the container side wall 51, thus pulling the door open, but other configurations may be used for different container types such as containers having a trap door opening upwardly from the vertical wall of the container. In the open position, the door actuator assembly 100 can be positioned to abut against a side wall 51 of the container 50. When the base plate 102 of the door actuator assembly 100 is positioned against the side wall 51, the actuating clamp 106 can move to a closed position. The clamps 106, 108 can grip the container 50 between the clamps 106, 108 as the clamp actuator 110 actuates the moveable clamp 106 to the closed position.

It is contemplated that the movement of the actuating clamps 106 can be accomplished through the use of the actuation arm 112 powered in a variety of ways, such as by an electrical motor, pneumatics, or hydraulic fluids. In the illustrated embodiment, the moveable clamp 106 has an elongate shape that is pivotally connected to the base plate 102 on one end. The clamp actuator assembly 111 is a linear actuator that includes the actuation arm 112 connected at a location of the clamp 106 such that, when the actuation arm 112 is retracted, the actuating clamp 106 will rotate inwardly towards the container 50. In such an embodiment, the actuating clamp 106 can pivot about a fixed pivot point 114. It is contemplated, however, that the actuating clamp 106 can move in a linear path, or can move in a linear path and pivot. In some embodiments, if the actuating clamp 106 is to be moved in a linear direction. Various actuation mechanisms can be used to pull the actuating clamp 106 in this fashion, such as a rack and pinion set, a ball screw, a linear puston, and other known mechanisms. It is also contemplated that the actuating clamp 106 can be moved without the use of an actuation arm 112. For example, it is contemplated that a rotary actuator can be mounted directly to the pivoting end of the actuating clamp 106 and directly rotate the actuating clamp with respect to the base plate 102.

The actuating or fixed clamps 106, 108 can be made from a rigid material, such a metal or plastic. The clamps 106, 108 can also include an elastic buffer (not shown) connected at least along the container engaging surface 107, 109 of each clamp that contacts the container 50 and can establish a secure grip. The elastic buffer can attach to the clamps 106, 108 using fasteners, interlocking joints, anchors, adhesive, or any other suitable manner.

An operator can control the movement of the actuating clamp 106 wirelessly using a remote control unit (not shown) or locally by activating a clamp switch 116 on the door actuator assembly 100. Referring to FIG. 4, the clamp switch 116 is disposed on the housing structure 103 in the illustrated embodiment, but it is contemplated that the clamp switch can be disposed elsewhere on the door actuator assembly. Any suitable wireless control device can be used as a remote control, such as a radio frequency identification (RFID) device, a cellular telephone, an infrared (IR) beam device, or any other device using other wireless technology, such as Bluetooth communication or wireless internet. Alternatively, a remote control device with a wired connection to the device may be used. When a user activates an appropriate button on the remote control unit, a wireless signal can be sent to a wireless receiver and controller 118 mounted on the door actuator assembly 100. In the illustrated embodiment, the wireless receiver and controller 118 is mounted on the housing structure 108, but can be mounted elsewhere on the door actuated assembly 100 in other embodiments. The wireless receiver and controller 118 receives the signal from the remote control unit and sends a signal to the actuator motor 110. The actuator motor 110 can then extend or retract the actuation arm 112 to open or close the actuating clamp 106 depending on the remote user's input. Similarly, a user can activate the clamp switch 116 on the door actuator assembly 100 to send an open or close signal to the clamp actuator assembly 111 that can move the actuating clamp 106 into the open or closed position as desired for operation.

In the illustrated embodiment, the housing structure 103 can be mounted to the top side 105 of the base plate 102. The housing structure 103 can include support walls 134 that extend perpendicularly from the base plate 102 along a rear edge of the base plate 102. The support walls 134 can be adjacent the side wall 51 of the container 50 when the assembly 100 is mounted to the container. In the illustrated embodiment, the support walls 134 can provide structural support to the door actuator assembly 100 and help position the base plate 102 relative to the container 50 during installation. A support bar 136 can extend across the base plate 102 between the support walls 134, as shown in FIG. 4, to provide cross bar support to the door actuator assembly 100.

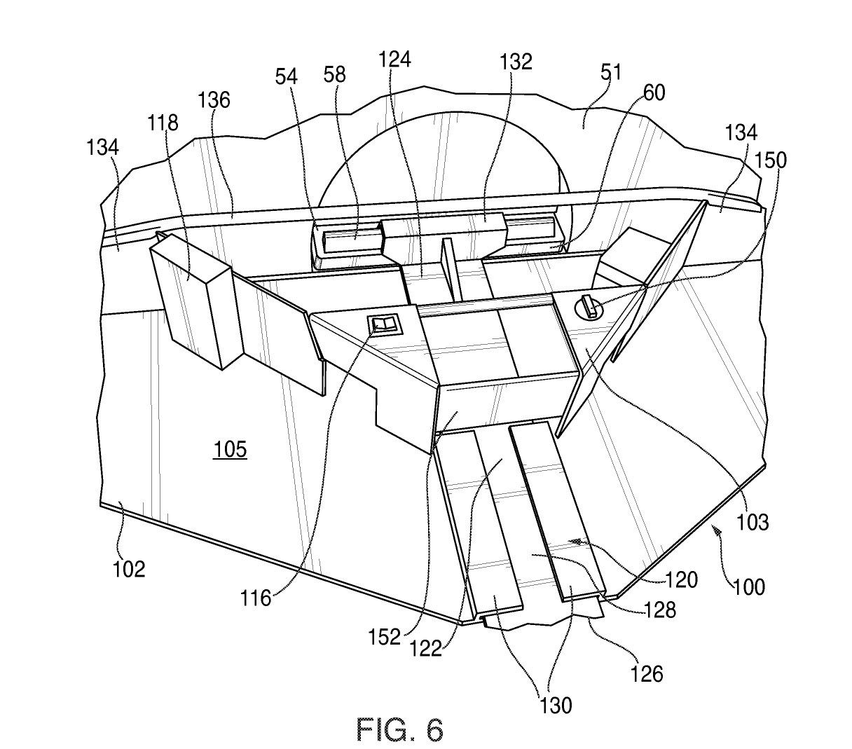

Referring now to FIG. 6, the hook assembly 120 can be mounted to the top side 105 of the base plate between the base plate and the housing structure 103. In the illustrated embodiment, the hook assembly 120 includes a hook member 122 having a hook end 124, an actuator end 126 opposite the hook end, and a body portion 128 disposed between the hook end and the actuator end. The hook assembly 120 can also include two guides 130 mounted to the top 105 of the base plate 102 that extend substantially parallel to one another. The body portion 128 of the hook member 122 can be slidably mounted to the base plate 102 and engaged between the guides 130, allowing for linear movement of the hook member 122.

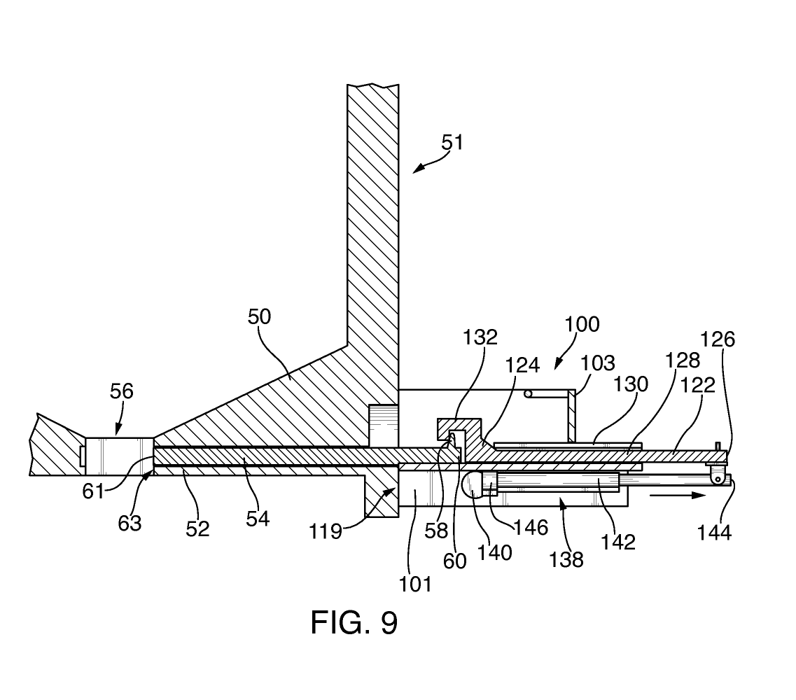

A hook 132 can be disposed at the hook end 124 of the hook member 122. As best seen in FIG. 8 and FIG. 9, the hook 132 can be adapted to mateably engage the trap door handle 58 of the trap door 54 when the door actuator assembly 100 is mounted to the container 50. In some embodiments, the hook 132 can have a “C” cross-sectional shape such that the two ends of the “C” face towards the ground and form a channel therebetween. In this configuration, the trap door handle 58 can fit between the two ends of the “C” and within the channel formed thereby such that axial forces can be applied to move the handle. The hook 132 can engage with the trap door handle 58 such that the trap door handle moves linearly toward or away from the container 50 when the hook moves linearly away from or toward the container. Thus, when the hook member 122 is made to move linearly away from or toward the container 50 within the guides 130, the trap door 54 can open and close, respectively. FIG. 6 and FIG. 8 show an embodiment of the door actuator assembly 100 with the hook assembly 120 positioned in the closed position, while FIG. 7 and FIG. 9 show the door actuator assembly with the hook assembly in the open position.

A hook actuator assembly 138 can be mounted to the base plate 102 and be configured to linearly actuate the hook member 122. In the illustrated embodiment, the hook actuator assembly 138 is mounted to the bottom side 104 of the base plate 102 and includes a hook actuator motor 140 and a hook actuation arm 142. The hook actuation arm 142 can have a base end 146 mounted to the base plate 102 and a distal end 144 fastened to the actuator end 126 of the hook member 122. The hook actuator motor 140 can be configured to extend and retract the hook actuation arm 142. The hook member 122 can be configured to move in response to the extension and retraction of the hook actuation arm 142. For instance, in the illustrated embodiment, when the hook actuation arm 142 extends, the hook member 122 can move away from the container 50, and when the hook actuation arm retracts, the hook member can move toward the container 50. When the hook member 122 is coupled to the trap door 54 via the hook 132, movement of the hook member causes the trap door to move into the closed position when the hook actuator arm 142 retracts, and causes the trap door to move into an open position when the hook actuator arm extends. FIG. 6 and FIG. 8 illustrate an embodiment of the door actuator assembly 100 with the trap door 54 in the closed position and the hook actuation arm 142 retracted, while FIG. 7 and FIG. 9 illustrate an embodiment of the door actuator assembly with the trap door in the open position and the hook actuation arm extended. It is also contemplated that various intermediate positions are possible between the fully open and fully closed trap door positions.

The hook actuator motor 140 associated with the hook assembly 120 can be controlled wirelessly through the same or a different remote control unit as is used to send signals to the clamp actuator motor 110. When a user activates a button or switch on the remote control unit, a signal is sent to the wireless receiver and controller 118, which sends a signal to the hook actuator motor 140 to extend the hook actuation arm 142. Extending the hook actuation arm 142 causes the hook member 122 to move away from the container 50, thereby moving the trap door 54 into an open position. Similarly, the user can activate a button or switch on the remote control unit to send another signal to the wireless controller and receiver 118, which sends a signal to the hook actuator motor 140 to retract the hook actuation arm 142. Retracting the hook actuation arm 142 causes the hook member 122 to move toward the container, thereby moving the trap door 54 into the closed position. As discussed above in reference to the clamp actuator assembly, the remote control unit used to operate the hook actuator assembly 120 can be any suitable wireless device capable of sending appropriate signals. Additionally, although the illustrated embodiment utilizes a single controller 118 to control both the clamp actuator motor 110 and the hook actuator motor 140, it is contemplated that each actuator can have a dedicated controller.

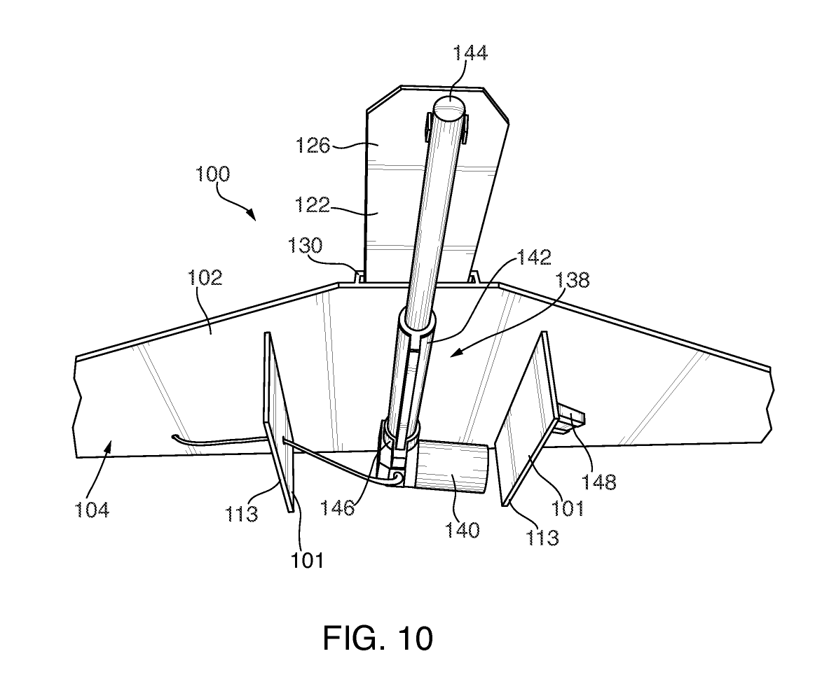

In the illustrated embodiment, the clamp actuator motor 110 that actuates the clamp actuator assembly 111 and the hook actuator motor 140 that actuates the hook assembly 120 are electrically powered stepper motors. Accordingly, in the embodiment illustrated in FIG. 10, the door actuator assembly 100 includes a power source 148 mounted to the bottom side 104 of the base plate 102. The power source 148 can supply power to the controller 118, which is then selectively provided to drive the hook actuator motor 140 and clamp actuator motor 110 in response to control signals. As discussed above, in some embodiments, the control signals are provided wirelessly by an operator using a remote control units. As shown in FIG. 6, if electrical motors are used, the door actuator assembly 100 may further include a fuse 150, one or more switches 116 for controlling movement of the actuating clamp assembly 111 and/or to otherwise control power in the door actuator assembly 100, and a cover or sheaths 152 for protecting wires and other electrical components. In alternative embodiments, hydraulic, pneumatic, or other types of power may be used to operate the clamp actuator assembly 111 and the hook actuator assembly 120. It is also contemplated that, in some embodiments, the hook actuator assembly 138 can be a rack and pinion set, a ball screw controlled by an electrical motor, or any other suitable actuating device. Moreover, the housing structure 103 and/or the base plate 102 can have a variety of shapes depending on the type of container 50 to which they are mounted, and the desired orientation of the door actuator assembly 100 relative to the container during operation.

### INDUSTRIAL APPLICABILITY

The door actuator assembly 100 described herein can be used to facilitate the unloading of aggregate material from a container remotely. During operation, an operator may begin by mounting the door actuator assembly 100 to the container 50 to be unloaded. This can be accomplished by positioning the door actuator assembly 100 with the clamps 106, 108 in the open position adjacent the container 50 so that the bottom edges 113 of the support plates 101 can rest on the ground and the inward edges 119 of the support plates can abut the side wall 51 of the container. The operator can then activate a button or switch on a remote control unit that can send a wireless signal to the clamp actuator motor 110 controlling the actuating clamp 106. The clamp actuator motor 110 can then cause the clamp actuation arm 112 to retract, moving the actuating clamp 106 into the closed position wherein the actuating clamp can be in contact with the container 50. The operator can then position the hook assembly 120 such that the hook 132 mateably engages the trap door handle 58. The hook 132 and the trap door handle 58 can be engaged such that when the hook assembly 120 moves away from the container 50, the trap door 54 moves to the open position, and when the hook assembly moves toward the container, the trap door moves to the closed position.

With the door actuation assembly 100 mounted to the container 50, the operator can lift the container along with the door actuation assembly over an area where it is desired to release some or all of the contents of the container. When the distribution orifice 56 is positioned above the desired distribution area, the operator can activate a button or switch on the remote control unit, sending a wireless signal from the remote control unit to the wireless receiver and controller 118. The wireless receiver and controller 118 can then send a signal to the hook actuator assembly 138 to extend the hook actuation arm 142, causing to trap door 54 to move into the open position. After a desired amount of container contents have been released from the container 50, the trap door 54 can be closed by pressing a button on the remote control unit, causing the hook actuator motor 140 to retract the hook actuation arm 142, thereby moving the trap door 54 into the closed position covering the distribution orifice 56.

Use of a powered hook actuator motor 140 to open and close the trap door 54 can provide an advantage over manual use in that friction and other forces opposing the motion of the trap door 54 can be more easily overcome by a powered motor than manual human power alone. The container 50 with the mounted door actuator assembly 100 can then be lowered to the ground, or repositioned above another distribution target if so desired. When distribution is complete, the door actuator assembly 100 can be removed from the container 50 by either using the remote control unit or by activating the clamp switch 116 on the door actuator assembly. This can signal the clamp actuator motor 110 to extend the clamp actuation arm 112, moving the actuating clamp 106 into the open position and releasing the container. In some embodiments, release of the door actuator assembly 100 from the container 50 using the remote control unit can be disabled to prevent accidental release of the door actuator assembly during distribution from the container. Alternatively, a safety latch can be used.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A door actuator assembly comprising:
a base plate adapted to be mounted to a container, the container including:
a distribution orifice; and
a trap door slidably mounted to the container such that the trap door is configured to move selectively between a closed position, in which the trap door fully covers the distribution orifice, and an open position, in which the trap door does not fully cover the distribution orifice;
a hook member slidably mounted to the base plate, the hook member including a hook disposed at a hook end of the hook member, the hook adapted to mateably engage with the trap door of the container such that the trap door is adapted to move linearly when the hook member moves linearly; and
a hook actuator assembly mounted to the base plate, the hook actuator assembly including a hook actuation arm coupled to the hook member;
wherein the hook actuation arm is adapted to extend and retract such that the hook actuation arm moves the hook member linearly along the base plate when the hook actuation arm extends and retracts, causing the hook member to move the trap door selectively between the closed position and the open position.

2. The door actuator assembly of claim 1, wherein the hook actuator assembly further includes a hook actuator motor configured to power the hook actuation arm to selectively extend and retract.

3. The door actuator assembly of claim 2, wherein the hook actuator motor is adapted to receive wireless signals instructing the hook actuator motor to selectively extend or retract the hood actuation arm.

4. The door actuator assembly of claim 2, further comprising a controller mounted to the base plate and electronically connected to the hook actuator motor, the controller adapted to receive wireless signals and transmit corresponding electronic signals to the hook actuator motor.

5. The door actuator assembly of claim 1 further comprising:
a fixed clamp extending from a first end of the base plate;
an actuating clamp pivotally mounted to and extending from a second end of the base plate such that the container is positionable between the fixed clamp and the actuating clamp when the base plate is mounted to the container;
a clamp actuator assembly mounted to the base plate, the clamp actuator assembly configured to selectively move the actuating clamp between a closed position, in which the actuating clamp and the fixed clamp are both in contacting relationship with the container, and an open position, in which at least one of the fixed clamp and the actuating clamp is not in contacting relationship with the container.

6. The door actuator assembly of claim 5, wherein the clamp actuator assembly comprises a clamp actuation arm configured to selectively retract or extend, the clam actuation arm coupled to the actuating clamp such that the actuating clamp is in the closed position when the clamp actuation arm is retracted, and the actuating clamp is in the open position when the clamp actuating arm is extended.

7. The door actuator assembly of claim 6, wherein the clamp actuator assembly further comprises a clamp actuator motor configured to power the clamp actuation arm to selectively extend and retract.

8. The door actuator assembly of claim 7, wherein the clamp actuator motor is adapted to receive electronic signals instructing the clamp actuator motor to selectively extend or retract the clamp actuation arm.

9. The door actuator assembly of claim 7, wherein the electronic signals are wireless signals.

10. A door actuator assembly comprising:
a base plate adapted to be mounted to a container, the container including:
a distribution orifice; and
a trap door slidably mounted to the container such that the trap door is configured to move selectively between a closed position, in which the trap door fully covers the distribution orifice, and an open position, in which the trap door does not fully cover the distribution orifice;
a hook member slidably mounted to the base plate, the hook member including a hook disposed at a hook end of the hook member, the hook adapted to mateably engage with the trap door of the container such that the trap door is adapted to move linearly when the hook member moves linearly;
a hook actuator assembly mounted to the base plate, the hook actuator assembly including:
a hook actuation arm coupled to the hook member, the hook actuation arm adapted to selectively extend and retract; and
a hook actuator motor configured to power the hook actuation arm to selectively extend and retract;
wherein the hook actuation arm moves the hook member linearly along the base plate when the hook actuation arm extends and retracts, causing the hook member to move the trap door selectively between the closed position and the open position;
a fixed clamp extending from a first end of the base plate;
an actuating clamp pivotally mounted to and extending from a second end of the base plate such that the container is positionable between the fixed clamp and the actuating clamp when the base plate is mounted to the container, the actuating clamp adapted to selectively move between a closed position, in which the actuating clamp and the fixed clamp are both in contacting relationship with the container, and an open position, in which at least one of the fixed clamp and the actuating clamp is not in contacting relationship with the container; and
a clamp actuator assembly mounted to the base plate, the clamp actuator assembly including:
a clamp actuation arm configured to selectively retract and extend, the clamp actuation arm coupled to the actuating clamp such that the actuating clamp is in the closed position when the clamp actuation arm is retracted, and the actuating clamp is in the open position when the clamp actuating arm is extended; and
a clamp actuator motor configured to selectively extend and retract the clamp actuation arm.

11. The door actuator assembly of claim 10, wherein the hook actuator motor is adapted to receive wireless signals instructing the hook actuator motor to selectively extend or retract the hood actuation arm.

12. The door actuator assembly of claim 10, further comprising a controller mounted to the base plate and electronically connected to the hook actuator motor, the controller adapted to receive wireless signals and transmit corresponding electronic signals to the hook actuator motor instructing the hook actuator motor to selectively extend or retract the hook actuation arm.

13. The door actuator assembly of claim 10, wherein the clamp actuator motor is adapted to receive electronic signals instructing the clamp actuator motor to selectively extend or retract the clamp actuation arm.

14. The door actuator assembly of claim 13, wherein the electronic signals are wireless signals.

15. The door actuator assembly of claim 13 further comprising a controller mounted to the base plate and electronically connected to the clamp actuator motor, the controller adapted to receive wireless signals and transmit corresponding electronic signals to the clamp actuator motor instructing the clamp actuator motor to selectively extend or retract the clamp actuation arm.

16. A door actuating method comprising:
mounting a base plate to a container, the container including:
a distribution orifice; and
a trap door slidably mounted to the container such that the trap door is configured to move selectively between a closed position, in which the trap door fully covers the distribution orifice, and an open position, in which the trap door does not fully cover the distribution orifice;
slidably mounting a hook member to the base plate, the hook member including a hook disposed at a hook end of the hook member mateably engaging the hook member with the trap door of the container such that the trap door is adapted to move linearly when the hook member moves linearly;
mounting a hook actuator assembly to the base plate, the hook actuator assembly including a hook actuation arm coupled to the hook member, the hook actuation arm adapted to selectively extend and retract; and
extending and retracting the hook actuation arm such that the hook actuation arm moves the hook member linearly along the base plate when the hook actuation arm extends and retracts, causing the hook member to move the trap door selectively between the closed position and the open position.

17. The door actuating method of claim 16, wherein the hook actuator assembly further includes a hook actuator motor configured to power the hook actuation arm to selectively extend and retract.

18. The door actuating method of claim 17, wherein the hook actuator motor is adapted to receive wireless signals instructing the hook actuator motor to selectively extend or retract the hood actuation arm.

19. The door actuating method of claim 16, the method further comprising:
mounting a fixed clamp to a first end of the base plate;
pivotally mounting an actuating clamp to a second end of the base plate such that the container is positionable between the fixed clamp and the actuating clamp when the base plate is mounted to the container; and
selectively moving the actuating clamp between a closed position, in which the actuating clamp and the fixed clamp are both in contacting relationship with the container, and an open position, in which at least one of the fixed clamp and the actuating clamp is not in contacting relationship with the container.

20. The door actuating method of claim 19, further comprising mounting a clamp actuator assembly to the base plate, the clamp actuator assembly comprising:
a clamp actuation arm configured to selectively retract or extend, the clam actuation arm coupled to the actuating clamp such that the actuating clamp is in the closed position when the clamp actuation arm is retracted, and the actuating clamp is in the open position when the clamp actuating arm is extended; and
a clamp actuator motor configured to power the clamp actuation arm to selectively extend and retract, the clamp actuator motor adapted to receive electronic signals instructing the clamp actuator motor to selectively extend or retract the clamp actuation arm.
